(19) United States
(12) Patent Application Publication
(10) Pub. No.: US 2014/0186062 A1
(43) Pub. Date: Jul. 3, 2014

(54) DEVELOPER CONTAINER UNIT, DEVELOPING UNIT, AND PROCESS CARTRIDGE

(71) Applicant: CANON KABUSHIKI KAISHA, Tokyo (JP)

(72) Inventors: Yoshihiro Mitsui, Numazu-shi (JP); Toshiya Kaino, Suntou-gun (JP); Keisuke Mochizuki, Suntou-gun (JP); Bunro Noguchi, Suntou-gun (JP); Akihisa Matsukawa, Yachimata-shi (JP); Shun Sato, Ashigarakami-gun (JP); Masahiro Shibata, Numazu-shi (JP); Hisashi Yamauchi, Numazu-shi (JP)

(73) Assignee: CANON KABUSHIKI KAISHA, Tokyo (JP)

(21) Appl. No.: 14/139,563

(22) Filed: Dec. 23, 2013

(30) Foreign Application Priority Data
Dec. 27, 2012 (JP) 2012-285802

(51) Int. Cl. G03G 15/08

(52) U.S. Cl. CPC G03G 15/0889
USPC 399/27

(57) ABSTRACT

A developer container unit includes a container containing developer and a piezoelectric film for detecting an amount of developer in the container. A sensitivity of the piezoelectric film to a stress in a direction parallel to a film surface is greater than a sensitivity of the piezoelectric film to a stress in a direction perpendicular to the film surface, and the piezoelectric film is deformable with a movement thereof relative to the developer.

### BACKGROUND OF THE INVENTION

1. Field of the Invention

The present invention relates to a developer container unit used for an image forming apparatus.

2. Description of the Related Art

Some existing developer container units used for image forming apparatuses, such as electrophotographic printers, include a detection mechanism that uses a piezoelectric element to detect the remaining amount of developer.

Japanese Patent Laid-Open No. 3-271785 describes an image forming apparatus that detects the amount of developer in a developer container unit on the basis of a pressure that the developer applies to a polymer piezoelectric plate that is attached to an agitation plate of an agitation member for agitating the developer. This agitation plate is a substantially rigid plate that does not deform. The polymer piezoelectric plate detects the amount of developer on the basis of a pressure applied thereto in the thickness direction.

It is difficult for the existing image forming apparatus described above to detect the amount of developer with high accuracy because the output from the polymer piezoelectric plate is limited to an output caused by strain of the piezoelectric plate in the thickness direction. The present invention provides an improved developer container unit that can detect the amount of developer with high accuracy.

### SUMMARY OF THE INVENTION

According to an aspect of the present disclosure, a developer container unit includes a container containing developer and a piezoelectric film for detecting an amount of developer in the container. A sensitivity of the piezoelectric film to a stress in a direction parallel to a film surface is greater than a sensitivity of the piezoelectric film to a stress in a direction perpendicular to the film surface, and the piezoelectric film is deformable with a movement thereof relative to the developer.

Further features of the present invention will become apparent from the following description of exemplary embodiments with reference to the attached drawings.

### BRIEF DESCRIPTION OF THE DRAWINGS

FIG. 1 is a schematic cross-sectional view of an image forming apparatus according to a first embodiment.

FIG. 2 is a schematic cross-sectional view of a process cartridge according to the first embodiment.

FIGS. 3A to 3C are schematic views illustrating an agitation member according to the first embodiment.

FIG. 4A is a schematic view of an existing mechanism for detecting the remaining amount of toner by using a polymer piezoelectric plate, and FIG. 4B is a schematic view of a mechanism for detecting the remaining amount of toner by using a piezoelectric film according to the first embodiment.

FIGS. 5A to 5F are schematic views illustrating how the amount of deformation of an agitation sheet of the agitation member changes in one cycle of rotation of the agitation member according to the first embodiment.

FIG. 6 is a graph representing a profile of an output voltage of the piezoelectric film according to the first embodiment.

FIG. 7A is a flowchart of a process of detecting the remaining amount of toner according to the first embodiment, and FIG. 7B is a graph representing the result of detecting the amount of toner.

FIG. 8 illustrates an example of how the piezoelectric film is attached to the agitation member according to the first embodiment.

FIGS. 9A and 9B are schematic cross-sectional views of a process cartridge according to a second embodiment.

### DESCRIPTION OF THE EMBODIMENTS

### First Embodiment

### (1) Overview of Structure and Operation of Image Forming Apparatus

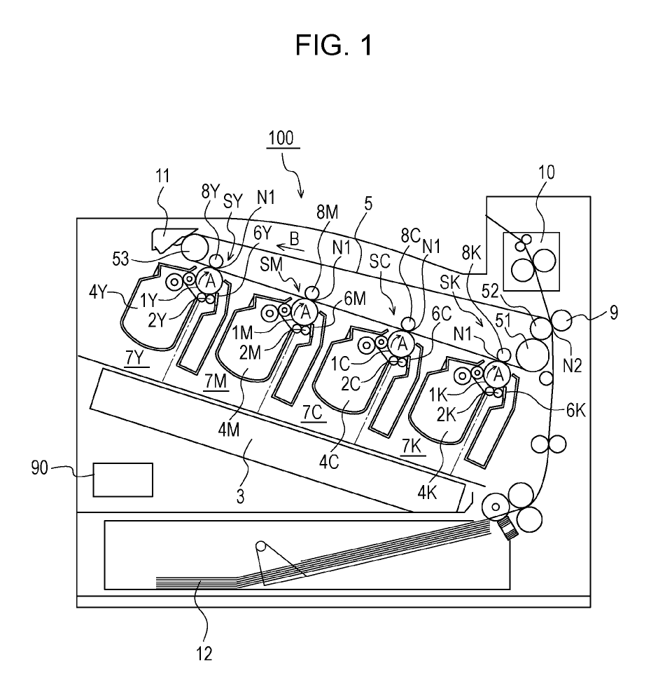

First, the overall structure of an electrophotographic image forming apparatus will be described. FIG. 1 is a schematic cross-sectional view of an image forming apparatus 100 according to the first embodiment. The image forming apparatus 100 is a full-color laser printer using a tandem method and an intermediate transfer method. The image forming apparatus 100 can form a full-color image on a recording medium (such as a recording sheet, a plastic sheet, or a piece of fabric) on the basis of image information. The image information is input from a host machine that is connected to an image forming apparatus body, such as an image reader or a personal computer that is communicatively connected to the image forming apparatus body.

The image forming apparatus 100 includes first, second, third, and fourth image forming units SY, SM, SC, and SK, which respectively form yellow (Y), magenta (M), cyan (C), and black (K) images. In the first embodiment, the first to fourth image forming units SY, SM, SC, and SK are arranged along a line that intersects the vertical direction.

In the first embodiment, the first to fourth image forming units have substantially the same structure and are operated in substantially the same way, except that they form images of different colors. Therefore, hereinafter, the characters Y, M, C, and K for denoting the colors will be omitted unless it is necessary to discriminate between the colors.

The image forming apparatus 100 includes four photoconductor drums 1 (electrophotographic photoconductors) that are arranged along a line that intersects the vertical direction. Each of the photoconductor drums 1 corresponds to an image carrier. The photoconductor drum 1 is rotated by a driving unit (not shown) in the direction of arrow A (clockwise direction) in FIG. 1. A charge roller 2 and a scanner unit 3 (exposure device) are arranged around the photoconductor drum 1. The charge roller 2 is a charger that uniformly charges the surface of the photoconductor drum 1. The scanner unit 3 is an exposure unit that irradiates the surface of the photoconductor drum 1 with a laser beam on the basis of image information so as to form an electrostatic image (electrostatic latent image) on the photoconductor drum 1. Moreover, a developing unit 4 (developer container unit) and a cleaning member 6 (cleaning unit) are arranged around the photoconductor drum 1. The developing unit 4 develops an electrostatic image into a toner image. The cleaning member 6 removes toner (residual toner) remaining on the photoconductor drum 1 after the toner image has been transferred. An intermediate transfer belt 5 (intermediate transfer body) is disposed so as to face the four photoconductor drums 1. The intermediate transfer belt 5 transfers toner images on the photoconductor drum 1 to a recording medium 12.

The developing unit 4 uses a non-magnetic single component toner as a developer. In the first embodiment, the developing unit 4 performs reversal development by making the developing roller (described below), which is a developer carrying member, contact the photoconductor drum 1. To be specific, in the first embodiment, the developing unit 4 develops an electrostatic image by making toner, which has been charged so as to have a polarity the same as that of the photoconductor drum 1 (in the first embodiment, a negative polarity), adhere to a portion (image portion, exposed portion) of the photoconductor drum 1 at which the charge has been weakened by irradiation of a laser beam.

The photoconductor drum 1, the charge roller 2 (a process unit acting on the photoconductor drum 1), the developing unit 4, and the cleaning member 6 are integrated with each other and constitute a process cartridge 7. The process cartridge 7 is attachable to and removable from the image forming apparatus 100 by means of attachment members, such as a guide member and a positioning member, which are disposed in the image forming apparatus body. In the first embodiment, all of the process cartridges 7 have the same shape and respectively contain yellow (Y), magenta (M), cyan (C), and black (K) toners.

The intermediate transfer belt 5 (intermediate transfer body) is an endless belt that is in contact with all of the photoconductor drums 1. The intermediate transfer belt 5 moves around (rotates) in the direction of arrow B (counterclockwise direction) in FIG. 1. The intermediate transfer belt 5 is looped over support members, including a drive roller 51, a secondary transfer opposing roller 52, and a driven roller 53.

Four primary transfer rollers 8 (primary transfer units) are arranged along an inner peripheral surface of the intermediate transfer belt 5 so as to respectively face the four photoconductor drums 1. Each of the primary transfer rollers 8 presses the intermediate transfer belt 5 toward a corresponding one of the photoconductor drums 1 and forms a primary transfer region N1 at which the intermediate transfer belt 5 and the photoconductor drum 1 contact each other. To each of the primary transfer rollers 8, a bias voltage having a polarity opposite to a regular polarity of the charge of toner is applied by a primary transfer bias power source (high-voltage power supply, not shown), which is a primary transfer bias application unit. Thus, toner images on the photoconductor drums 1 are transferred (primarily transferred) to the intermediate transfer belt 5.

A secondary transfer roller 9 (second transfer unit) is disposed outside of the intermediate transfer belt 5 at a position facing the secondary transfer opposing roller 52. The secondary transfer roller 9 is in pressed against the secondary transfer opposing roller 52 with the intermediate transfer belt 5 therebetween so as to form a secondary transfer region N2 at which the intermediate transfer belt 5 and the secondary transfer roller 9 contact each other. To the secondary transfer roller 9, a bias voltage having a polarity opposite to the regular polarity of the charge of toner is applied by a secondary transfer bias power source (high-voltage power supply, not shown), which is a secondary transfer bias application unit. Thus, toner images on the intermediate transfer belt 5 are transferred (secondarily transferred) to the recording medium 12.

When the image forming apparatus 100 forms an image, first, the charge roller 2 uniformly charges the surface of the photoconductor drum 1. Next, the scanner unit 3 emits a laser beam on the basis of image information, the charged surface of the photoconductor drum 1 is scanned by the laser beam, and thereby an electrostatic image based on the image information is formed on the photoconductor drum 1. Next, the developing unit 4 develops the electrostatic image formed on the photoconductor drum 1 into a toner image. The primary transfer roller 8 transfers (primarily transfers) the toner image formed on the photoconductor drum 1 to the intermediate transfer belt 5.

When forming a full-color image, the first to fourth image forming units SY, SM, SC, and SK successively perform the operation described above, and thereby color toner images are primarily transferred to the intermediate transfer belt 5 in an overlapping manner.

Subsequently, the recording medium 12 is transported to the secondary transfer region N2 in synchronism with the movement of the intermediate transfer belt 5. Then, the secondary transfer roller 9, which is pressed against the intermediate transfer belt 5 with the recording medium 12 therebetween, simultaneously secondarily-transfers the four-color toner images on the intermediate transfer belt 5 to the recording medium 12.

The recording medium 12, to which the toner images have been transferred, is transported to a fixing device 10 (fixing unit). The fixing device 10 applies heat and pressure to the recording medium 12, and thereby the toner images are fixed to the recording medium 12.

The cleaning member 6 removes and recovers toner remaining on the photoconductor drum 1 after the primary transfer operation has been finished. An intermediate transfer belt cleaning device 11 removes toner remaining on the intermediate transfer belt 5 after the secondary transfer operation has been finished.

The image forming apparatus 100 may form a monochrome or a multi-color image by using one or more (but not all of the) image forming units.

### (2) Process Cartridge

The overall structure of the process cartridge 7 mounted in the image forming apparatus 100 according to the first embodiment will be described.

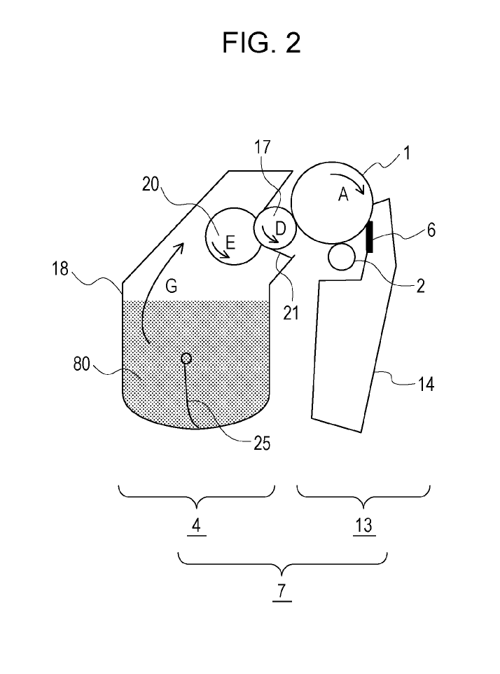

FIG. 2 is a schematic cross-sectional view of the process cartridge 7 according to the first embodiment, seen in the longitudinal direction of the photoconductor drum 1 (the direction of the rotation axis). In the first embodiment, the process cartridges 7 for the four colors have substantially the same structure and are operated in the substantially same way, except that they contain developers of different types (colors).

The process cartridge 7 includes a photoconductor unit 13, which includes the photoconductor drum 1 and other components, and the developing unit 4, which includes a developing roller 17 and other components.

The photoconductor unit 13 includes a cleaning frame body 14 for supporting various components of the photoconductor unit 13. The photoconductor drum 1 is rotatably mounted on the cleaning frame body 14 through bearings (not shown). A driving force of a driving motor (not shown) is transmitted to the photoconductor unit 13, and the photoconductor drum 1 is rotated in the direction of arrow A (clockwise direction) in accordance with an image formation operation. The photoconductor drum 1 is a main component for performing an image formation process. The photoconductor drum 1 is an organic photoconductor drum including an aluminum cylinder whose peripheral surface is coated with functional layers, including an undercoat layer, a carrier generating layer, and a carrier transport layer in this order.

The photoconductor unit 13 includes the cleaning member 6 and the charge roller 2, which are in contact with the peripheral surface of the photoconductor drum 1. The cleaning member 6 removes residual toner on the surface of the photoconductor drum 1. The residual toner drops into and is contained in the cleaning frame body 14.

The developing unit 4 includes the developing roller 17, a developing blade 21, a toner supply roller 20, a toner 80 used for development, and a toner container 18.

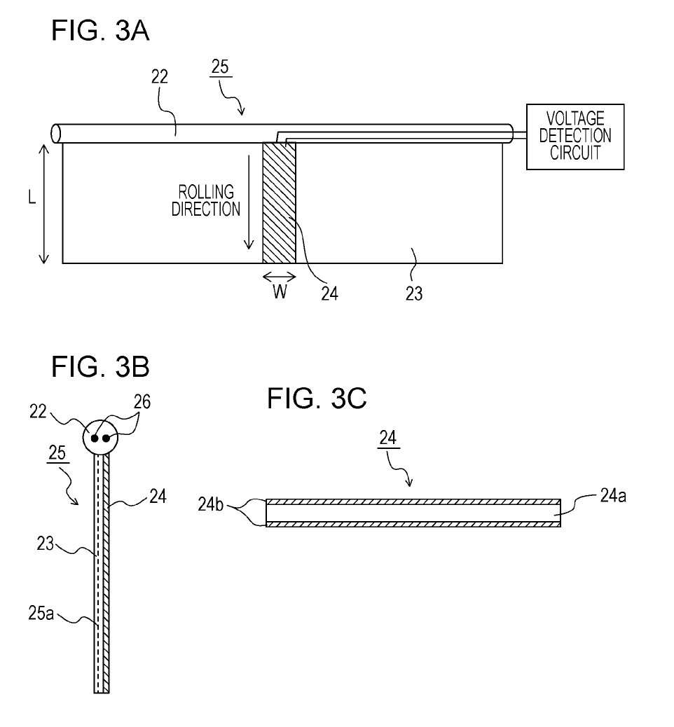

An agitation member 25 for agitating toner is disposed in the toner container 18. The agitation member 25 includes a rotary shaft 22, an agitation sheet 23 (flexible sheet) one end of which is fixed to the rotary shaft 22, and a piezoelectric film 24 (see FIGS. 3A and 3B) affixed to the agitation sheet 23. When the driving unit (not shown) rotates the rotary shaft 22, the agitation sheet 23 agitates toner contained in the toner container 18 and transports the toner toward an upper portion of the toner supply roller 20 in the direction of an arrow G in FIG. 2. In the first embodiment, the agitation member is rotated when the developing unit performs development.

The developing blade 21 is in contact with the developing roller 17 in a counter direction to the developing roller 17. The developing blade 21 regulates the amount of toner with which the surface of the developing roller 17 is coated. The developing blade 21 also charges the toner. The developing blade 21 is a thin plate-shaped member that generates an elastic force with which the developing blade 21 is pressed against the developing roller 17. The surface of the developing blade 21 is in contact with the toner and the developing roller 17. The developing roller 17 rotates in the direction of an arrow D, and the toner is charged with triboelectricity generated by friction between the developing blade 21 and the developing roller 17. At the same time, the developing roller 17 regulates the thickness of the toner. A blade bias power source (not shown) applies a predetermined voltage to the developing blade 21, so that coating with toner can be stably performed.

In a region (contact region) in which the developing roller 17 and the photoconductor drum 1 face each other, the surfaces of the developing roller 17 and the photoconductor drum 1 move in the same direction (in the first embodiment, upward). In the first embodiment, the developing roller 17 is in contact with the photoconductor drum 1. Alternatively, the developing roller 17 may be disposed at a predetermined small distance from the photoconductor drum 1.

In the first embodiment, the toner is negatively charged with triboelectricity. Because a predetermined DC bias is applied to the developing roller 17, an electrostatic latent image is developed into a visible image as the toner is transferred to only exposed portions of the photoconductor drum 1 that have been irradiated with a laser beam.

The toner supply roller 20 and the developing roller 17 are disposed so as to form a nip therebetween. The toner supply roller 20 rotates in the direction of an arrow E in FIG. 2 (counterclockwise direction). The toner supply roller 20 is an elastic sponge roller including an electroconductive core metal whose peripheral surface is coated with a foam material. The toner supply roller 20 and the developing roller 17 are in contact with each other so that the surface of the toner supply roller 20 is recessed by a predetermined amount. In the nip region, the toner supply roller 20 and the developing roller 17 rotate in opposite directions. The toner supply roller 20 supplies toner to the developing roller 17 in the nip region and subsequently removes toner from the developing roller 17.

The developing roller 17 and the toner supply roller 20 each have an outer diameter of φ20, and the developing roller 17 is pressed against the toner supply roller 20 so that the surface of the toner supply roller 20 is recessed by the amount of 1.5 mm.

### (3) Structure of Agitation Member and Method of Detecting Remaining Amount of Toner

### (3-1) Structure of Agitation Member

FIG. 3A is a schematic view of the agitation member 25, FIG. 3B is a schematic cross-sectional view of the agitation member 25 seen in the axial direction, and FIG. 3C is an enlarged cross-sectional view of the piezoelectric film 24. The piezoelectric film 24 is made by Tokyo Sensor Co., Ltd. and has a thickness of 20 μm. The material of the piezoelectric film 24 is polyvinylidene fluoride (PVDF). The piezoelectric film 24 includes a piezopolymer (PVDF) substrate 24a and silver-ink electrodes 24b formed on both surfaces of the piezopolymer substrate 24a.

The sensitivity (piezoelectricity) of the piezoelectric film 24 to a stress in a direction parallel to a film surface is greater than the sensitivity (piezoelectricity) of the piezoelectric film 24 to a stress in a direction perpendicular to the film surface. The sensitivity of the piezoelectric film 24 to a compressive stress is greater than the sensitivity of the piezoelectric film 24 to a tensile stress. In particular, the sensitivity to a tensile stress in a rolling direction, in which the piezoelectric film 24 was rolled in a manufacturing process, is the highest. The piezoelectric film 24 is bonded to the agitation sheet 23 so that the rolling direction is perpendicular to the axial direction of the agitation member 25. The agitation sheet 23 is electrically insulating. As illustrated in FIG. 3B, in the first embodiment, the piezoelectric film 24 having a width of 10 mm is bonded to a middle portion of the agitation sheet 23 in the longitudinal direction so as to be integrated with the agitation sheet 23. The agitation sheet 23 has flexibility to a bending stress and a sufficient elastic resilience to a bending stress. The material of the agitation sheet 23 is polyphenylene sulfide and the thickness of the sheet is 150 μm. The silver-ink electrodes 24b of the piezoelectric film 24 are connected to metallic films and metallic wires (not shown) extending to the outside and are connected to a voltage detection circuit of the image forming apparatus body through sliding electrodes 26. A signal generator 90 (see FIG. 1), which is disposed in the image forming apparatus body, generates an alarm signal for raising an alarm about the amount of toner on the basis of an output voltage of the piezoelectric film 24. The signal generator 90 corresponds to an alarm signal generator.

By disposing the piezoelectric film 24 on the agitation sheet 23 as described above, a slight change in toner-powder pressure can be detected by using a piezoelectric film having a relatively small area.

The operational effects of the structure of the first embodiment will be described below in comparison with the structure an agitation member of a related-art example, which is described in Japanese Patent Laid-Open No. 3-271785.

The piezoelectric film is thin and flexible. Because the film is thin and has a very small cross-sectional area, a greater stress is generated by a small tension in a direction parallel to the film surface. In particular, the piezoelectric film has the highest sensitivity to a tension in the rolling direction. The ratio of the standard effective sensitivity in the rolling direction to that in the thickness direction is about 1000:1. With the first embodiment, the toner-powder pressure can be detected with a high sensitivity by effectively utilizing such characteristics of the piezoelectric film 24.

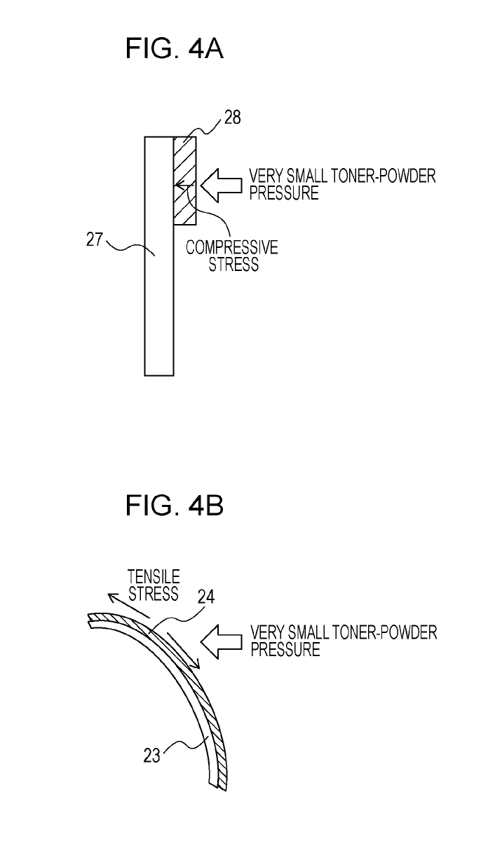

FIGS. 4A and 4B illustrate a comparison between the structure of the related-art example and the structure of the first embodiment. As illustrated in FIG. 4A, the idea of the related-art example is converting a toner-powder pressure in the thickness direction of a polymer piezoelectric plate 28 into a deformation amount (strain amount) of the polymer piezoelectric plate 28 in the thickness direction and then converting the deformation amount into a voltage. Because the piezoelectric plate 28 of the related-art example receives a toner-powder pressure in the thickness direction, a substantially rigid body is used as an agitation plate 27 so that the agitation plate 27 does not deform. With such a structure, when the piezoelectric plate 28 receives a toner-powder pressure in the thickness direction, the piezoelectric plate 28 deforms only in such a way that the piezoelectric plate 28 contracts in the thickness direction. The Young's modulus of a general polymer piezoelectric element is in the range of 2 to 4×10⁹N/m². Therefore, it is clear that the piezoelectric plate 28 deforms only slightly in the thickness direction when a very small toner-powder pressure is applied to the piezoelectric plate 28. Accordingly, a stress generated in the piezoelectric plate 28 is very small. As a result, with the structure of the related-art example, only a very low voltage is generated when the toner-powder pressure changes.

In contrast, with the structure of the first embodiment illustrated in FIG. 4B, the piezoelectric film 24, which is a thin film, is bonded to a deformable surface of the agitation sheet 23, which is a flexible member having elastic resilience, so as to be integrated with the surface. Thus, as illustrated in FIG. 4B, a very small toner-powder pressure can be converted into a large extensional deformation in the rolling direction.

As illustrated in FIG. 3B, the piezoelectric film 24 is bonded to the agitation sheet 23 so as to be integrated with the agitation sheet 23. The piezoelectric film 24 is located at a position separated from a neutral axis 25a of the agitation member 25 (which is a neutral axis in a cross section perpendicular to the film surface, along which extension and contraction do not occur when the agitation member 25 deforms). Thus, a large strain can be generated in the piezoelectric film 24 when the agitation sheet 23 deforms.

In the first embodiment, the agitation sheet 23 has a free end. Therefore, a very small toner-powder pressure can cause a large deformation of the agitation sheet 23 and a large change in voltage.

In the first embodiment, the piezoelectric film 24 is disposed so that the amount of deformation of the piezoelectric film 24 in the rolling direction, in which the piezoelectric film 24 has the highest sensitivity, is greater than the amount of deformation of the piezoelectric film 24 in a direction perpendicular to the rolling direction. However, even if the piezoelectric film 24 is disposed so that the amount of deformation of the piezoelectric film 24 in the width direction perpendicular to the rolling direction is larger, an advantage of a sensitivity greater than that of the related-art example can be obtained in principle. For example, the piezoelectric film 24 may be disposed so that the rolling direction of the piezoelectric film 24 coincides with the axial direction of the rotary shaft 22.

In the first embodiment, the piezoelectric film 24 is affixed to a portion of the agitation sheet 23 that is in the middle in the longitudinal direction and that extends from one end to the other end of the agitation sheet 23 in the transversal direction (radial direction from the rotary shaft). However, this is not a limitation. For example, the piezoelectric film 24 may be affixed only to a portion of the agitation sheet 23 near the free end or to any appropriate portion of the agitation sheet 23 in accordance with the structure of the agitation member and the structure of the developer container.

### (3-2) Overview of Output Voltage Profile of Piezoelectric Film

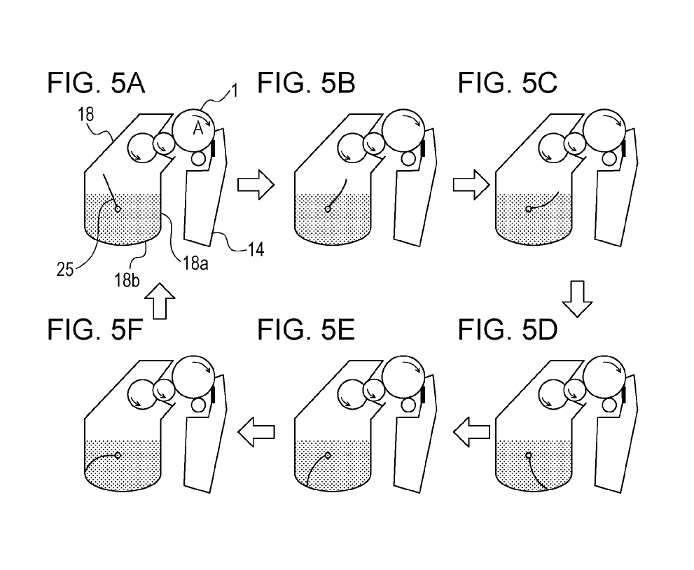

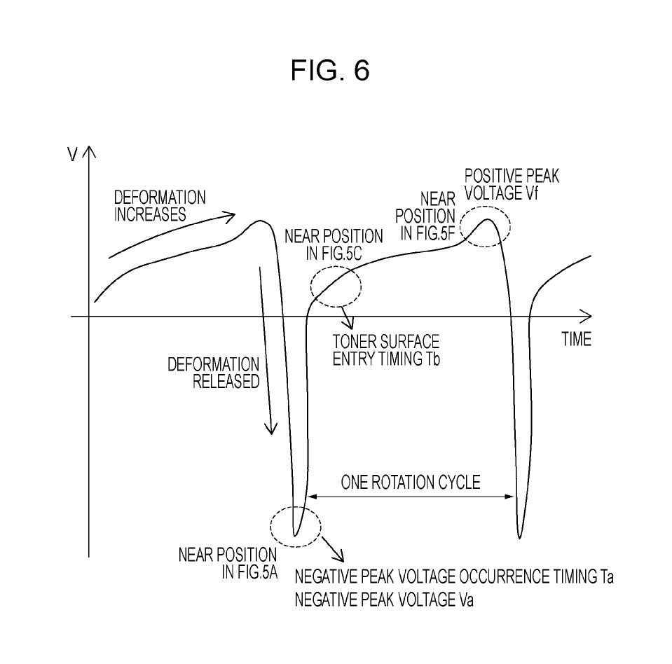

FIGS. 5A to 5F are schematic views illustrating how the amount of deformation of the agitation sheet 23 changes in one cycle of rotation of the agitation member 25 according to the first embodiment. FIG. 6 is a graph representing a profile of an output voltage generated between the electrodes 24b of the piezoelectric film 24 as the agitation member 25 rotates.

The relationship between the amount of deformation of the agitation sheet 23 illustrated in FIGS. 5A to 5F and the profile illustrated in FIG. 6 will be described. The agitation sheet 23 starts rotation from the position illustrated in FIG. 5A, an end portion of the agitation sheet 23 enters through the surface of toner in FIGS. 5B and 5C, and thereby deformation of the agitation sheet 23 occurs. At the same time, the piezoelectric film 24 generates a voltage in accordance with the amount of deformation. Subsequently, the amount of deformation increases as illustrated in FIGS. 5D to 5E and becomes the largest in FIG. 5F. In FIG. 5A, the deformation is suddenly released. At this time, the agitation sheet 23 deforms in a direction such that the agitation sheet 23 returns to its original shape. As illustrated in FIG. 6, due to the change of the direction of deformation and a sharp change in the amount of deformation, the piezoelectric film 24 generates a peak voltage in the negative direction.

As illustrated in FIGS. 5D to 5E, in order to efficiently transport the toner, the free end of the agitation sheet 23 slides over the bottom wall of the container. Because the characteristics of the piezoelectric film 24 are efficiently used, the structure of the first embodiment has a very high detection sensitivity. Therefore, a slight change in the toner-powder pressure can be detected from an output of the piezoelectric film 24 even when the output includes an influence of a change in the amount of deformation caused by contact with the bottom wall.

### (3-3) Method of Detecting Remaining Amount of Toner

In the profile illustrated in FIG. 6, the values of the following parameters change in accordance with the remaining amount of toner.

Parameters that change in accordance with Remaining Amount of Toner

(i) negative peak voltage occurrence timing Ta, negative peak voltage Va

(ii) toner surface entry timing Tb

(iii) positive peak voltage Vf

(iv) integral value of profile for one cycle of agitation member

examples: integral value α=sum of absolute value of output voltage

integral value β=sum of positive output voltage

integral value γ=sum of negative output voltage

Referring to the profile shown in FIG. 6, how and why the values of the parameters (i) to (iv) change when the amount of toner decreases will be described.

When the amount of toner (developer) decreases, the surface of the toner becomes lower (in FIG. 2 and other figures) and the amount of toner agitated by the agitation sheet 23 decreases.

Because the surface of the toner becomes lower and the amount of toner agitated by the agitation sheet 23 decreases, the timing at which the amount of deformation of the agitation sheet 23 starts decreasing is advanced, and therefore the negative peak voltage occurrence timing Ta ((i)) is advanced in one rotation cycle of agitation. For the same reason, the maximum amount of deformation of the agitation sheet decreases, the amount of recovery of the agitation sheet 23 decreases, and therefore the negative peak voltage Va decreases.

Because the toner surface becomes lower, the toner surface entry timing Tb ((ii)) is delayed. Because the total amount of toner agitated by the agitation sheet 23 decreases, the maximum amount of deformation of the agitation sheet 23 decreases, and therefore the positive peak voltage Vf ((iii)) decreases.

The integral value of the profile ((iv)) decreases as the surface of the toner become lower decreases and the amount of toner agitated by the agitation sheet 23 decreases.

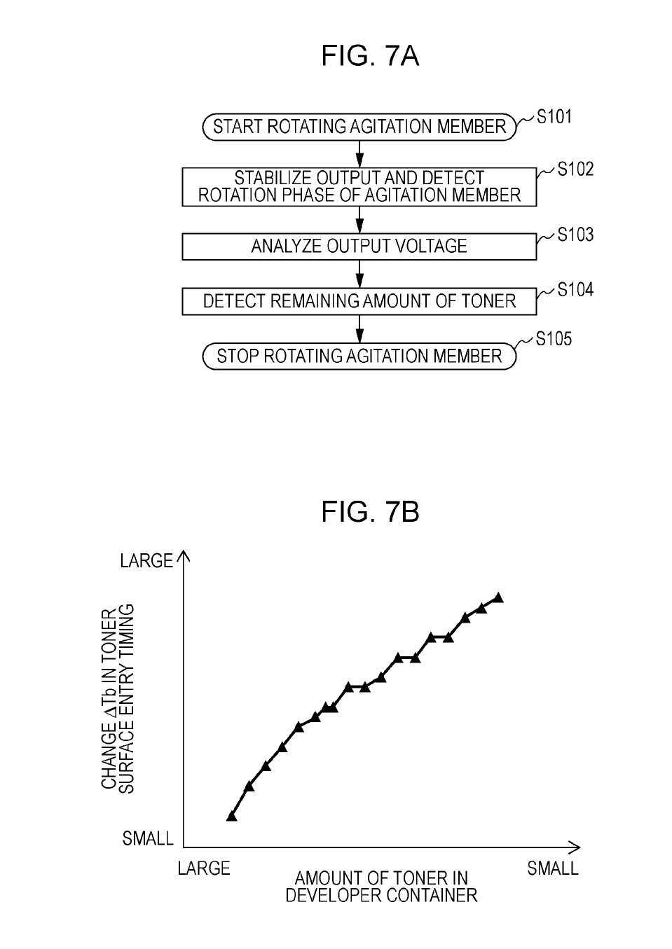

FIG. 7A is a flowchart of a process of detecting the amount of toner. In step S101, rotation of the agitation member 25 is started. Immediately after rotation of the agitation member 25 is started, in step S102, stabilization of the output and detection the rotation phase of the agitation member are performed. In the structure of the first embodiment, after a printing operation is started and the agitation member has rotated twice, it is possible to stabilize the output and detect the rotation phase. In step S103, the output voltage of the piezoelectric film 24 is analyzed. In step S104, the amount of toner is detected. In step S105, rotation of the agitation member 25 is stopped.

FIG. 7B illustrates the relationship between the amount of toner and a change ΔTb in the toner surface entry timing Tb ((ii)) when the amount of toner in the developer container decreases as the image forming apparatus according to the first embodiment performs a printing operation. Here, ΔTb is the difference between the value of Tb when the toner container is full (initial) and the value of Tb when the amount of toner decreases (now). As illustrated in FIG. 7B, there is a correlation between ΔTb and the amount of toner, and therefore it is possible to successively detect the amount of toner.

As illustrated in FIG. 7B, ΔTb is used in the first embodiment. Alternatively, any of the aforementioned parameters of the output voltage profile, whose values change in accordance with the amount of toner, and a combination of such parameters may be used. The aforementioned parameters, whose values change in accordance with the amount of toner, may be selectively used in accordance with the structure of the agitation member and the structure of the developer container. The parameters used may be changed in accordance with the amount of toner.

The agitation sheet 23 is disposed so that the free end of the agitation sheet 23 does not contact the inner wall of the container at a timing at which the agitation sheet 23 enters through the toner surface (when the agitation sheet 23 is near the positions shown in FIGS. 5C and 5D). That is, when the agitation sheet 23 rotates downward, the agitation sheet 23 reaches a bottom wall 18b of the container without contacting a side wall 18a of the developer container. Thus, the accuracy of detection of the toner surface entry timing Tb can be further increased.

In the first embodiment, as illustrated in FIG. 5A, at a timing at which the agitation sheet emerges through the toner surface (when the agitation sheet 23 is near the position shown in FIG. 5A), the free end of the agitation sheet does not contact the inner wall of the container. Therefore, the amount of extension and the speed of extension of the agitation sheet can be increased, and the accuracy of detection of the amount of toner can be increased further when detecting the amount of toner by using the negative peak voltage occurrence timing Ta and the negative peak voltage Va.

The structure and the advantage of the first embodiment are mainly as follows.

The developing unit 4 according to the first embodiment includes the toner container 18 containing toner and the piezoelectric film 24 for detecting the amount of toner in the developer container. The sensitivity of the piezoelectric film 24 to a stress in a direction parallel to a film surface is greater than the sensitivity of the piezoelectric film 24 to a stress in a direction perpendicular to the film surface. Thus, the amount of toner can be detected with high accuracy.

The piezoelectric film 24 is rotatable in the developer container, and the sensitivity of the piezoelectric film 24 to a stress in a direction parallel to the film surface and perpendicular to the rotation axis of the piezoelectric film 24 is greater than the sensitivity of the piezoelectric film to a stress in a direction of the rotation axis. Thus, when the piezoelectric film 24 rotates, a force that the piezoelectric film 24 receives from the toner is efficiently converted into a voltage, and thereby the accuracy of detection of the amount of toner can be further increased. The sensitivity of the piezoelectric film 24 to a stress in the direction parallel to the film surface and perpendicular to the rotation axis of the piezoelectric film 24 is greater than the sensitivity of the piezoelectric film 24 to a stress in any other directions parallel to the film surface. Thus, the accuracy of detection of the amount of toner can be further increased.

The piezoelectric film 24 is integrated with the agitation sheet 23 having an elastic resilience greater than that of the piezoelectric film 24, and the piezoelectric film 24 and the agitation sheet 23 constitute the agitation member 25 that agitates the toner. Thus, high accuracy of detection of the amount of toner and high agitation performance of the agitation member can be both obtained. The piezoelectric film 24 is located at a position separated from a neutral axis of the agitation member 25 in a cross section of the agitation member 25 along a plane perpendicular to the film surface. Thus, the accuracy of detection of the amount of toner can be further increased. The piezoelectric film 24 is disposed on a surface of the agitation member 25 on a downstream side in a rotation direction of the agitation member 25 (see FIG. 4B). Thus, when the agitation member 25 rotates, the piezoelectric film 24 can efficiently deform, and the accuracy of detection of the amount of toner can be further increased.

The length L of the piezoelectric film 24 in a direction perpendicular to the rotary axis of the piezoelectric film 24 is greater than the length W of the piezoelectric film 24 in the direction of the rotation axis. Accordingly, the piezoelectric film 24 can efficiently deform and the accuracy of detection of the amount of toner can be further increased.

The piezoelectric film 24 is disposed close to or in contact with the rotary shaft. Accordingly, the piezoelectric film 24 can be electrically connected to the image forming apparatus body easily.

In the first embodiment, the flexible piezoelectric film 24 is affixed to the flexible agitation sheet 23 so as to be integrated with the flexible agitation sheet 23. Alternatively, the agitation sheet 23 and the piezoelectric film 24 may be disposed so as to be rotatable independently, and the piezoelectric film 24 may be only used to detect the amount of toner.

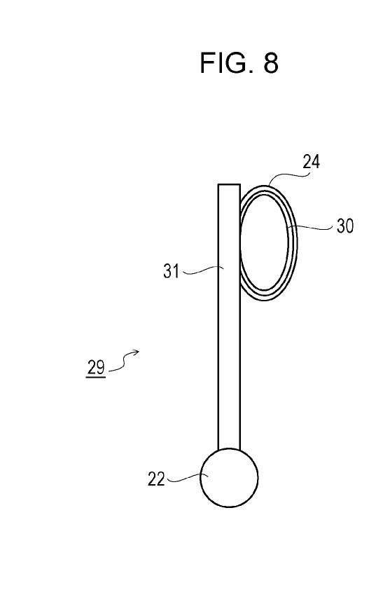

For example, an advantage the same as that of the first embodiment can be obtained by using an agitation member illustrated in FIG. 8. FIG. 8 illustrates an agitation member 29 including the piezoelectric film 24 affixed to a flexible sheet 30 having elastic resilience. The flexible sheet 30 is rolled up and is attached to an agitation paddle 31 that is a substantially rigid body and that does not deform. Also with this structure, the amount of toner can be detected with high accuracy.

In the first embodiment, the piezoelectric film 24 is disposed on the surface of the agitation member on the downstream side in the rotation direction of the agitation member. Alternatively, the piezoelectric film 24 may be disposed on the surface of the agitation sheet on the upstream side. Further alternatively, the piezoelectric film 24 may be sandwiched between a plurality of agitation sheets. As long as the piezoelectric film 24 is deformable as described above, an output voltage obtained with the first embodiment is greater than that of existing structures, which is dependent on deformation in the thickness direction. Therefore, the amount of toner can be detected with high accuracy.

### Second Embodiment

In the first embodiment, the piezoelectric film 24 is disposed on the agitation sheet 23. In the second embodiment, the piezoelectric film 24 is independent from the agitation sheet 23, and the piezoelectric film 24 is disposed on the inner wall of the developer container. Components of the second embodiment the same as those of the first embodiment will not be described.

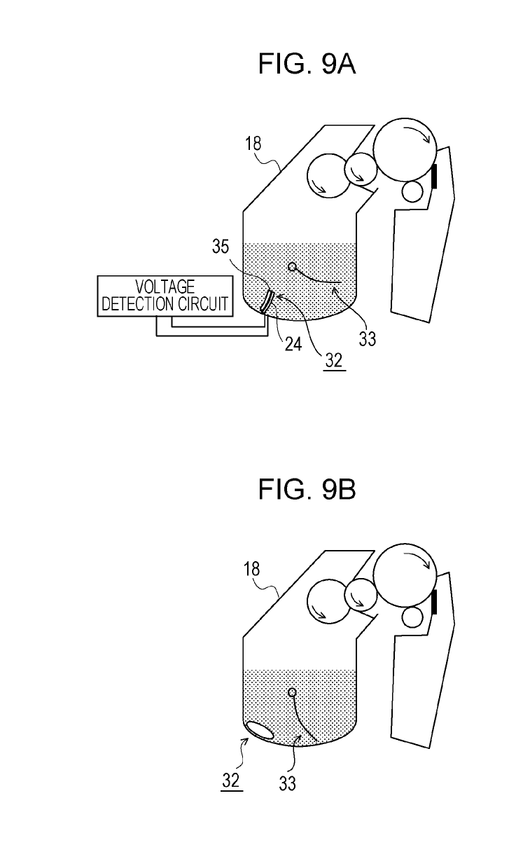

FIG. 9A is a schematic cross-sectional view of a process cartridge according to the second embodiment. As illustrated in FIG. 9A, a toner-amount detection member 32 is attached to an inner wall (bottom wall) in a lower portion of the developer container. The toner-amount detection member 32 corresponds to a developer-amount detection member. The toner-amount detection member 32 includes a flexible sheet 35 having a thickness of 100 μm and the piezoelectric film 24 the same as that of the first embodiment. The piezoelectric film 24 is bonded to the flexible sheet 35 so as to be integrated with the flexible sheet 35. The material of the flexible sheet 35 is PPS. As in the first embodiment, when an agitation member rotates, the toner-amount detection member 32 receives a toner-powder pressure and deforms. In order to maximize the sensitivity of the piezoelectric film 24, the piezoelectric film 24 is affixed to the flexible sheet 35 so that the piezoelectric film 24 deforms in a direction in which the piezoelectric film 24 has the highest sensitivity as an agitation member 33 rotates.

The toner-amount detection member 32 is affixed to a middle portion of the inner wall of the developer container in the longitudinal direction. The width of the toner-amount detection member 32 in the longitudinal direction of the developer container is 10 mm. The length of the toner-amount detection member 32 from a free end to a fixed end that is fixed to the inner wall of the developer container is 20 mm. With such a structure, the accuracy of detection of the amount of toner can be increased while suppressing the influence of decrease in the agitation performance due to the presence of the toner-amount detection member.

As in the first embodiment, electrodes are formed on both surfaces of the piezoelectric film 24, and the electrodes are connected to a voltage detection circuit of the image forming apparatus body. As compared with the first embodiment, the second embodiment can be manufactured easily because the electrodes for detecting the voltage generated in the piezoelectric film have a simpler structure. With the first embodiment, it is necessary to electrically connect the piezoelectric film 24, which is affixed to the agitation sheet 23, to the output voltage detector of the image forming apparatus through sliding electrodes. In contrast, with the second embodiment, it is not necessary to use the sliding electrodes. Instead, it is only necessary to electrically connect the piezoelectric film 24 to the outside of the container through the inner wall of the container.

In the second embodiment, the toner-amount detection member 32 is disposed on the bottom surface of the toner container 18. Thus, after the amount of toner has decreased to a certain level, the amount of deformation of the toner-amount detection member 32 changes for every rotation cycles of the agitation member. The amount of toner can be detected with high accuracy from the profile of voltage generated in the piezoelectric film 24 at this time.

The structure and the advantage of the second embodiment are mainly as follows.

The developing unit 4 according to the second embodiment includes the toner container 18 containing toner and the piezoelectric film 24 for detecting the amount of toner in the developer container. The sensitivity of the piezoelectric film 24 to a stress in a direction parallel to a film surface is greater than the sensitivity of the piezoelectric film 24 to a stress in a direction perpendicular to the film surface. Thus, as in the first embodiment, the amount of toner can be detected with high accuracy.

The piezoelectric film 24 is integrated with the flexible sheet 35 having an elastic resilience greater than that of the piezoelectric film 24, and the piezoelectric film 24 and the flexible sheet 35 constitute the toner-amount detection member 32. The toner-amount detection member 32 is attached to the inner wall of the toner container 18, and the toner-amount detection member 32 deforms when the agitation member 33 agitates the toner. Thus, the piezoelectric film 24 easily returns to its original shape after deforming as the agitation member 33 agitates the toner. Therefore, the accuracy of detection of the amount of toner can be increased. As compared with the first embodiment, the structure of electrical contacts connected to the piezoelectric film 24 can be simplified.

The piezoelectric film 24 is located at a position separated from the neutral axis of the toner-amount detection member 32. Thus, the accuracy of detection of the amount of toner can be further increased. The piezoelectric film 24 is disposed on the surface of the toner-amount detection member 32 on the upstream side in the rotation direction of the agitation member 33. Thus, when the agitation member 33 rotates, the piezoelectric film 24 can efficiently deform, and the accuracy of detection of the amount of toner can be further increased.

In the second embodiment, the agitation member 33 is disposed so that the agitation member 33 contacts the toner-amount detection member 32 while the agitation member 33 agitates the toner. By doing so, it is possible to detect an output voltage that is specifically generated at the instant at which the agitation member 33 contacts the toner-amount detection member 32. Therefore, as compared with the first embodiment, the rotation phase of the agitation member can be easily detected in principle. Accordingly, the accuracy of analysis the output voltage is increased and the accuracy of detection is increased.

In the second embodiment, the toner-amount detection member 32 is disposed on the inner wall of the developer container so as to have a free end. Alternatively, the toner-amount detection member 32 may be rolled up and disposed as illustrated in FIG. 9B. Also with such a structure, the advantage of the present invention can be obtained.

In the second embodiment, the piezoelectric film 24 and the flexible sheet 35 are integrated with each other. Alternatively, only the piezoelectric film 24 may be attached to the inner wall of the developer container. By doing so, as compared with the first embodiment, the structure of electrical contacts connected to the piezoelectric film can be simplified. In this case, in order to facilitate detection of the rotation phase of the agitation member 33, the agitation member 33 may be disposed so as to contact the piezoelectric film when agitating the toner.

In the second embodiment, the piezoelectric film 24 is disposed on the surface of the toner-amount detection member 32 on the upstream side in the rotation direction of the agitation member 33. Alternatively, the piezoelectric film 24 may be disposed on the surface of the toner-amount detection member 32 on the downstream side. Further alternatively, the piezoelectric film 24 may be sandwiched between a plurality of flexible sheets. As long as the piezoelectric film 24 is deformable as described above, an output voltage obtained with the second embodiment is higher than that of existing structures, which is dependent on deformation in the thickness direction. Therefore, the amount of toner can be detected with high accuracy.

With the present invention, a developer container unit that can detect the remaining amount of developer with higher accuracy can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-285802, filed Dec. 27, 2012, which is hereby incorporated by reference herein in its entirety.

What is claimed is:

1. A developer container unit comprising:
a container containing developer; and
a piezoelectric film for detecting an amount of developer in the container,
wherein a sensitivity of the piezoelectric film to a stress in a direction parallel to a film surface is greater than a sensitivity of the piezoelectric film to a stress in a direction perpendicular to the film surface, and the piezoelectric film is deformable with a movement thereof relative to the developer.

2. The developer container unit according to claim 1,
wherein the piezoelectric film is rotatable in the container, and the sensitivity of the piezoelectric film to a stress in the direction parallel to the film surface and perpendicular to a rotation axis of the piezoelectric film is greater than a sensitivity of the piezoelectric film to a stress in a direction of the rotation axis.

3. The developer container unit according to claim 2,
wherein the sensitivity of the piezoelectric film to a stress in the direction parallel to the film surface and perpendicular to the rotation axis of the piezoelectric film is greater than a sensitivity of the piezoelectric film to a stress in any other direction parallel to the film surface.

4. The developer container unit according to claim 2,
wherein a length of the piezoelectric film in the direction perpendicular to the rotation axis is greater than a length of the piezoelectric film in the direction of the rotation axis.

5. The developer container unit according to claim 1,
wherein the piezoelectric film is integrated with a flexible sheet having an elastic resilience greater than that of the piezoelectric film, and the piezoelectric film and the flexible sheet constitute an agitation member that agitates the developer.

6. The developer container unit according to claim 5,
wherein the piezoelectric film is located at a position separated from a neutral axis of the agitation member in a cross section of the agitation member along a plane perpendicular to the film surface.

7. The developer container unit according to claim 5,
wherein the piezoelectric film is disposed on a surface of the agitation member on a downstream side in a rotation direction of the agitation member.

8. The developer container unit according to claim 5,
wherein, when the agitation member rotates downward, the agitation member reaches a bottom wall of the container without contacting a side wall of the container.

9. The developer container unit according to claim 1, further comprising:
an agitation member that agitates the developer,
wherein the piezoelectric film is attached to an inner wall of the container, and the piezoelectric film deforms when the agitation member agitates the developer.

10. The developer container unit according to claim 1, further comprising:
an agitation member that agitates the developer,
wherein the piezoelectric film is integrated with a flexible sheet having an elastic resilience greater than that of the piezoelectric film, and the piezoelectric film and the flexible sheet constitute a developer-amount detection member, and
wherein the developer-amount detection member is attached to an inner wall of the container, and the developer-amount detection member deforms when the agitation member agitates the developer.

11. The developer container unit according to claim 10,
wherein the piezoelectric film is located at a position separated from a neutral axis of the developer-amount detection member in a cross section of the developer-amount detection member along a plane perpendicular to the film surface.

12. The developer container unit according to claim 11,
wherein the piezoelectric film is disposed on a surface of the developer-amount detection member on an upstream side in a rotation direction of the agitation member.

13. The developer container unit according to claim 9,
wherein the agitation member contacts the piezoelectric film when agitating the developer.

14. The developer container unit according to claim 10,
wherein the agitation member contacts the developer-amount detection member when the agitation member agitates the developer.

15. A developing unit comprising:
the developer container unit according to claim 1; and
a developer carrying member that carries the developer and develops an electrostatic image.

16. A process cartridge comprising:
an image carrier that carries an electrostatic image; and
the developing unit according to claim 15,
wherein the process cartridge is attachable to and removable from an image forming apparatus body.

17. An image forming apparatus for forming an image on a recording medium, the image forming apparatus comprising:
the developer container unit according to claim 1, and
an alarm signal generator that generates an alarm signal on the basis of an output of the piezoelectric film, the alarm signal raising an alarm about an amount of developer in the container.

18. An image forming apparatus for forming an image on a recording medium,
wherein the image forming apparatus is configured so that the developer container unit according to claim 1 is attachable to and removable from the image forming apparatus, and
wherein the image forming apparatus comprises an alarm signal generator that generates an alarm signal on the basis of an output of the piezoelectric film, the alarm signal raising an alarm about an amount of developer in the container.

19. An image forming apparatus for forming an image on a recording medium,
wherein the image forming apparatus is configured so that the process cartridge according to claim 16 is attachable to and removable from the image forming apparatus, and
wherein the image forming apparatus comprises an alarm signal generator that generates an alarm signal on the basis of an output of the piezoelectric film, the alarm signal raising an alarm about an amount of developer in the container.

20. An image forming apparatus for forming an image on a recording medium, the image forming apparatus comprising:
the process cartridge according to claim 16; and
an alarm signal generator that generates an alarm signal on the basis of an output of the piezoelectric film, the alarm signal raising an alarm about an amount of developer in the container.
